(19) United States
(12) Patent Application Publication
(10) Pub. No.: US 2014/0308600 A1
(43) Pub. Date: Oct. 16, 2014

(54) Novel Polymer Networks Based on the Benzimidazole Moiety for High Performance Polymer Electrolyte Membrane Fuel Cells

(71) Applicant: Advent Technologies Inc., East Hartford, CT (US)

(72) Inventors: Christos L. Chochos, Athens (GR); Vasilis G. Gregoriou, East Hartford, CT (US)

(73) Assignee: Advent Technologies Inc., East Hartford, CT (US)

(21) Appl. No.: 14/253,339

(22) Filed: Apr. 15, 2014

Related U.S. Application Data
(60) Provisional application No. 61/812,368, filed on Apr. 16, 2013.

(51) Int. Cl. C08G 73/18; H01M 8/10; H01M 4/90

(52) U.S. Cl. CPC C08G 73/18; H01M 4/9008; H01M 8/103; H01M 8/1004; H01M 2300/0082
USPC 429/480; 528/423; 502/159

(57) ABSTRACT

New polymeric networks bearing benzimidazole units have been prepared. These polymeric networks will combine high proton conductivity, superior mechanical properties and thermal and oxidative stability due to the existence of polar benzimidazole groups and the presence of the unique polymeric architecture. The prepared polymer networks can be used in the catalyst ink of the electrodes in high temperature PEM fuel cells.

### CROSS REFERENCE TO RELATED APPLICATIONS

This patent application claims a benefit to the filing date of U.S. Provisional Patent Application Ser. No. 61/812,368 that was filed on Apr. 16, 2013 and is titled “Novel Polymer Networks Based on the Benzimidazole Moiety for High Performance Polymer Electrolyte Membrane Fuel Cells.” The disclosure of U.S. No. 61/812,368 is incorporated herein in its entirety.

### FIELD OF INVENTION

This invention is related to the development of new polymeric networks bearing benzimidazole units. These polymeric networks will combine the high ionic conductivity due to the polar benzimidazole groups which enable high acid uptake with the relatively high mechanical and thermal stability due to the presence of the unique polymeric architecture. The combination of the above mentioned properties confirm the potential of the new prepared polymeric networks to be dispersed in the catalyst ink of the electrodes in high temperature PEM fuel cells.

### BACKGROUND INFORMATION

Fuel cells offer a reliable solution to the environmental friendly energy production since they have the flexibility to be adapted to the diverse energy sources. Among the different types of fuel cells, polymer electrolyte membrane fuel cells (PEMFCs) have the highest potential for market penetration addressing automotive and stationary applications.

Up to now, perfluorosulfonic ionomer membranes such as Nafion (Du Pont) and similar materials by other manufacturers as well as alternative polymeric materials based on aromatic backbones (Mauritz and Moore 2004) have been tested as polymer electrolyte membranes in fuel cells. According to the operation temperature, PEMFCs can be classified in three subcategories. The traditional low temperature PEMFCs with operating temperature up to 80° C. mainly due to their need for humidified gases since their high performance is closely related to the hydration level of the membrane. Medium temperature PEMFCs are considered those with operation temperatures between 80° C. and 130° C. which are able to operate with low humidity gases. This operating temperature range is the most preferable for automotive application and the working principle of medium temperature PEMFCs is based on the use of composite membranes operating under low humidity conditions or heterocycle based Brønsted bases that can act as anhydrous proton conductors. More specifically, heterocycles such as imidazole, pyrazole or benzimidazole have been demonstrated to be useful substitutes for water at temperatures up to 140° C. The small molecules or “low molecular proton solvents” exhibited moderate conductivities in the liquid state which was ascribed to some degree of self-dissociation and they are known for extraordinary thermal and/or chemical stability and have transport coefficients similar to those of water at higher temperatures. Similar to water, they are able to form hydrogen-bond networks, they are amphoteric and undergo autoprotolysis to a much higher degree than water leading to high proton conductivity even in the pure state. However, a general disadvantage of all low molecular weight proton solvents is their volatility and hence, a high temperature application requires their immobilization in the polymer membrane where a high local mobility of the proton solvent and the protonic charge carriers therein has still to be guaranteed.

High temperature PEM fuel cells (140° C. -200° C.) offer the distinct advantages of high carbon monoxide (CO) tolerance, enhanced kinetics on both electrodes, easier thermal management and the ability to use stack waste energy for heat cogeneration increasing the total efficiency and are the preferable choice for stationary applications. Polymeric materials of particular properties have to be used as electrolytes for high temperature MEAs in order to withstand the harsh conditions during the fuel cell operation. The polymeric material should possess good mechanical, thermal, chemical and oxidative stability, high glass transition temperature and high proton conductivity while the membrane electrode assembly (MEA) should possess good mechanical stability, long term chemical stability under continuous operation and cycling conditions and small voltage drop.

Among the different ideas, the one that seems more mature and reliable is based on materials that combine acid-base interactions in order to acquire high proton conductivity (10″¹ S cm⁻¹) at temperatures ranging between 140° C. and 200° C. Polybenzimidazole (PBI) is one of the state of the art high temperature polymer electrolytes, combining high thermal stability with increased proton conductivity after doping with phosphoric acid. The polymeric membranes are imbibed with phosphoric acid so that the proton acceptor sites of the benzimidazole ring interact with the phosphoric acid molecules due to acid-base interactions providing conducting materials. Although PBI based systems have been extensively studied at various operating conditions, there are some drawbacks with regards to its moderate mechanical properties, specifically for the doped membranes with phosphoric acid, and low oxidative stability (Li, Jensen et al. 2009). There is a significant research effort towards the development of some novel polymeric architectures which can be used alternatively to linear structure of PBI. One case is the simpler polybenzimidazole derivative poly(2,5-benzimidazole) (ABPBI) that has been investigated as an alternative fuel cell membrane material. ABPBI doped with phosphoric acid provide membranes which are stable at the operating temperatures of high temperature PEM fuel cells.

Microporous polymer networks (MPNs) are covalently bound organic architectures with exceptionally high porosity and surface areas, which allow the incorporation of functional organic moieties into solid materials (Thomas 2010). The high porosities are in general generated from structure-directing monomers (called knots or tectons), mostly rigid molecules with multiple functional groups extending into two (2D) or three (3D) dimensions. These tectons can be polymerized directly or with aid of linear linkers to generate the two- or three-dimensional networks. Several protocols have been applied to connect tectons of various structures, including metal-catalyzed couplings, condensation reactions, oxidative polymerizations, trimerizations and click reactions. The high porosity and chemical stability as well as the possibility to introduce functional organic moieties into the frameworks make these materials interesting for applications like gas storage, catalysis and sensing.

The field of MPNs has shown dramatic expansion over the last 10-15 years, and the literature has grown especially rapidly in the last 5 years or so. MPNs have a promising future: they can combine high surface areas, good physicochemical stability, and an ever-increasing degree of functional modularity.

Key recent synthetic breakthroughs are:
2004: Solution-processable, film-forming MPNs (Budd, Ghanem et al. 2004)
2007: Synthesis of crystalline MPNs with exceptionally high surface areas (El-Kaderi, Hunt et al. 2007).
2007: MPNs which combine porosity with extended conjugation (Chinchilla and Najera 2007).
2008/2009: More robust crystalline MPN analogues (Uribe-Romo, Hunt et al. 2009).
2009: Robust and highly porous aromatic frameworks (Ben, Ren, et al. 2009).
2011: Metal-organic MPNs (MO-MPNs) comprising catalytic metal centers (Jiang, Wang, et al. 2011).

This rapid advancement in synthetic capability has given researchers a broad toolkit for constructing new materials, and we would anticipate that the next 5 years of research will focus more closely on the applications of MPNs. There are many opportunities here which could take advantage of this synthetic modularity, for example:
Photochemical water splitting—perhaps exploiting extended conjugation in MPNs along with the ability to append redox-active metals.
Molecular imprinting—new analogues of imprinting technologies that were developed using more traditional vinyl crosslinking chemistry.
Sensing—high surface area porous sensors based on semiconducting MPNs, perhaps in combination with imprinting technologies, above, to sense particular guests.
CO₂ separation—large scale, processable MPN membranes which separate specific gases, such as CO₂, sorbents for pressure- and/or temperature-swing adsorption.
Artificial enzymes—for example, using self-assembled reactive metal sites within porous scaffolds.
Energy applications—for example, MPNs as material platforms for new batteries and supercapacitors.

A number of challenges also need to be addressed. For example, while linear polymers are soluble in organic solvents, networks are not easily dissolved in organic media and this raises the question of how these materials can best be processed into functional devices. These challenges, along with the development of applications for MPN materials, constitutes a fertile area of research for materials chemists working in collaboration with researchers in other related disciplines such as energy, health, and sustainability.

### SUMMARY OF THE INVENTION

The relentless increase in the demand for useable power from energy-hungry economies continues to drive energy-material related research. Fuel cells, as a future potential power source that provide clean-at-the-point-of-use power offer many advantages such as high efficiency, high energy density, quiet operation, and environmental friendliness. Critical to the operation of the fuel cell is the proton exchange membrane (polymer electrolyte membrane) responsible for internal proton transport from the anode to the cathode. PEMs have the following requirements: high protonic conductivity, low electronic conductivity, impermeability to fuel gas or liquid, good mechanical toughness in both the dry and hydrated states, and high oxidative and hydrolytic stability in the actual fuel cell environment. One of the most successful systems so far for high temperature PEMFC is the phosphoric acid-doped polybenzimidazole membrane. It has achieved long-term durability with a degradation rate of 5-10 μV/h under continuous operation with hydrogen and air at 150-160° C. In addition, a performance loss of 300 μV per cycle or 40 μV/h per operating hour has been observed with load or thermal cycling. However, further improvement should be attained by optimizing the thermal and chemical stability of the polymer, the acid-base interaction and acid management, the activity and stability of catalyst and more importantly the catalyst support, as well as the integral interface between electrode and membrane. Therefore, in this project we propose the development of novel microporous polymer networks membranes based on benzimidazole unit for the first time in high temperature PEMFCs in order to overcome the aforementioned current limitations. The three-dimensional (3D) structure of the polymer networks will provide enhanced mechanical stability therefore further increasing the long-term durability at elevated temperatures above 250° C.

### DETAILED DESCRIPTION OF THE INVENTION

The present invention relates to the development of new polymeric network materials (structures 1 and 2) comprising copolymers bearing benzimidazole moiety. The structures of the materials are given below.

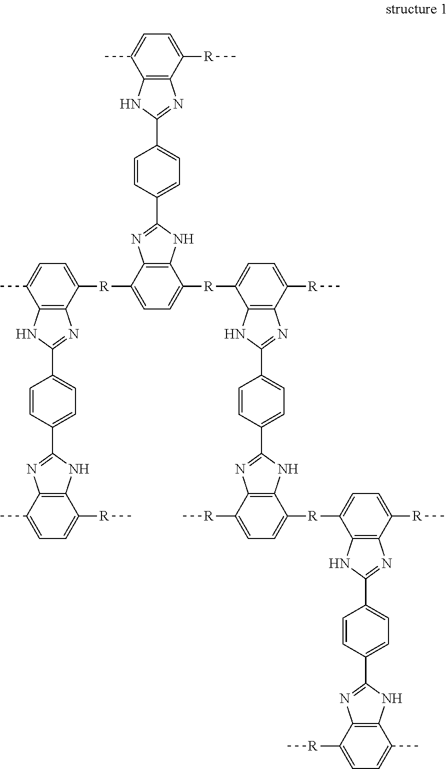

wherein R is selected from the group consisting of:

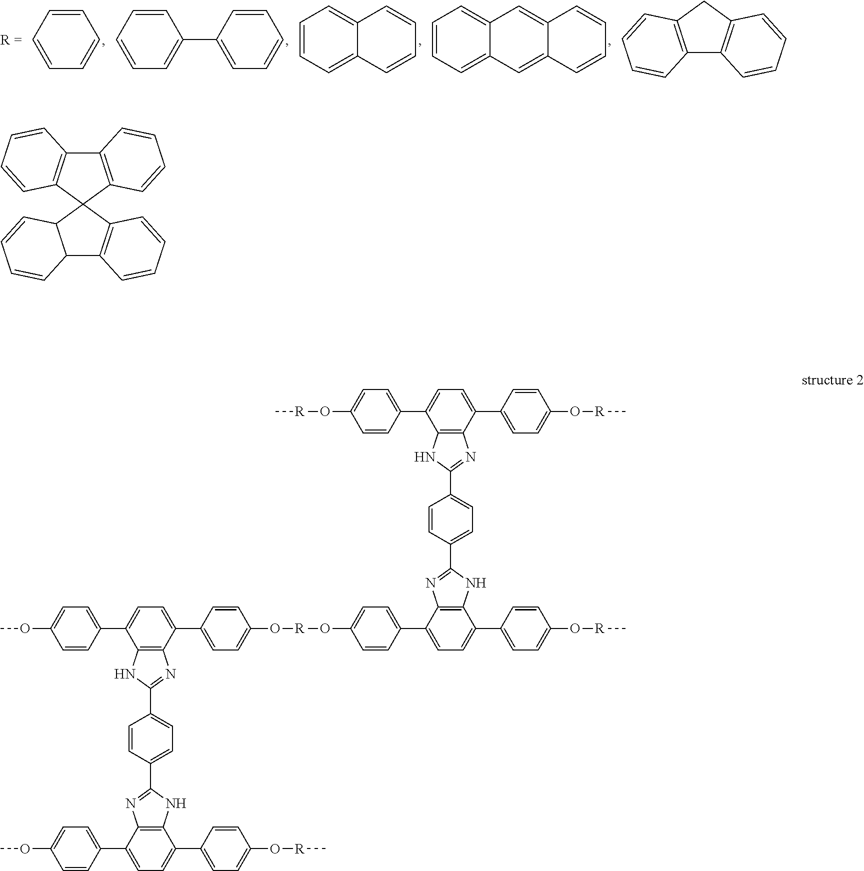

wherein R can be the same or different and is selected from the group consisting of:

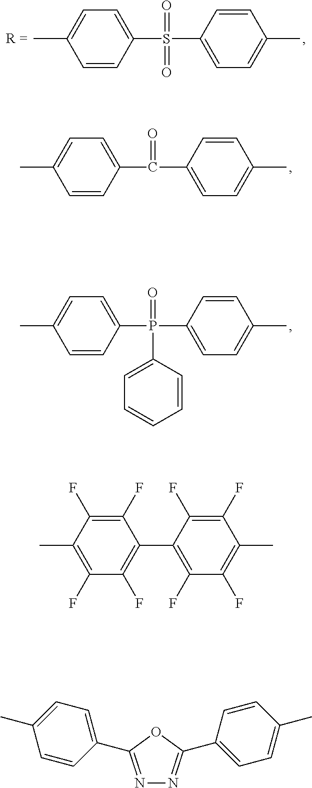

The above multifunctional material (structures 1-2) were prepared via Suzuki or

Stille cross coupling polymerization using tetrabromo bisbenzimidazoles with either boronic acids (esters) or distannyl derivatives containing phenyl, biphenyl, naphthalene, anthracene, fluorene and spirofluorene (Structure 1), or high temperature polycondensation reaction of benzimidazole containing diols and various aromatic difluorides (e.g., bis-(4-fluorophenyl)sulfone, bis-(4-fluorophenyl)phenylphosphine oxide, 4,4′-difluorobenzophenone, decafluorobipheynyl, 2,5-bis(4-fluorophenyl)-1,3,4-oxadiazole, and the like) (Structure 2).

The present invention relates to a method for implementing membrane electrode assemblies using the new polymeric networks as described herein. The method for implementing of membrane electrode assembly includes (a) a gas diffusion and current collecting electrode component, (b) a reaction layer component comprising of a catalyst and a multifunction material which can act as paths for electron and proton conduction (structures 1-2) and (c) Pt alloy electrocatalysts for enhanced CO tolerance and oxygen reduction reaction activity.

### The Gas Diffusion Electrode Component

The electrically conducting substrate is selected from a combination of woven carbon cloth (such as Toray fiber T-300) or paper (such as the Toray TGP-H-120), previously wet-proofed using TFE based solutions (DuPont, USA). The typical porosity of this carbon substrate is between 75-85%. The wet proofing is achieved with a combination of dip coating for fixed duration (between 30 sec to 5 min) followed with drying in flowing air. Such a wet proofed substrate can be coated with a gas diffusion layer comprising of select carbon blacks and PTFE suspension. The choice of carbon blacks used in this layer range from Ketjen black to turbostratic carbons such as Vulcan XC-72 (Cabot Corp, USA) with typical surface areas in the range of 250 to 1000 m²/gm. The deposition can be applied with a coating machine such as Gravure coaters from Euclid coating systems (Bay City, Mich., USA). A slurry composition comprising of carbon black and PTFE (poly tetrafluoro ethylene) in aqueous suspension (such as Dupont TFE-30, Dupont USA) is applied to a set thickness over the carbon paper or cloth substrate with the aid of the coating machine Typical thickness of 50-500 microns is used. Pore forming agents are used to prepare this diffusion layer on the carbon conducting paper or cloth substrate. Careful control of the pore formers which consist of various combinations of carbonates and bicarbonates (such as ammonium and sodium analogs) affords control of gas access to the reaction zone. This is achieved by incorporation of these agents in the slurry mixture comprising of carbon black and PTFE suspension. Typical porosity rendered in this fashion differs from anode and cathode electrode and is in the range of 10-90%. Coated carbon substrates containing the gas diffusion layers are sintered to enable proper binding of components. This can be achieved using thermal treatment to temperatures significantly above the glass transition point for PTFE, usually in the range 100 to 350° C. for 5 to 30 minutes.

### Formation of Reaction Layer Comprising of Electrocatalyst and Ion Conducting Components

On the surface of the above mentioned gas diffusion layer, an additional layer comprising of a carbon supported catalyst, polymeric networks (structure 1-2), pore forming agents, is added using a variety of methods comprising of spraying, calendaring and or screen printing.

Typical steps first include appropriate choice of the electrocatalyst based on anode or cathode electrodes. For the anode, pure Pt or Pt in conjunction of another transition metal such as Ru, Mo, Sn is used. This is motivated by the formation of oxides on these non noble transition metals at lower potentials to enable oxidation of CO or other C₁ moieties which are typical poisons in the output feed of fuel reformers (steam reformation of natural gas, methanol, etc.). The choice of electrocatalyst included Pt and second transition element either alloyed or in the form of mixed oxides. The choice is dependent on the application based on choice of fuel feed-stock. The electrocatalysts are in the form of nanostructured metal alloys or mixed oxide dispersions on carbon blacks (turbostratic carbon support materials usually Ketjen black or similar material).

For the cathode, electrocatalysts which are relatively immune from anion adsorption and oxide formation are preferred. The choice of the alloying element ranges between available first row transition elements, typically Ni, Co, Cr, Mn, Fe, V, Ti, etc. Previous studies have shown that adequate alloying of these transition elements with Pt results in deactivation of Pt for most surface processes (lowering of surface workfunction) (Mukerjee and Urian 2002; Teliska, Murthi et al. 2003; Murthi, Urian et al. 2004; Teliska, Murthi et al. 2005). This renders the surface largely bare for molecular oxygen adsorption and subsequent reduction. The electrocatalyst can be obtained from commercial vendors such as Columbian Chemicals (Marrietta, Ga., USA), Cabot Superior Micro-powders (Albuquerque, N.Mex., USA). The typical weight ratio of the catalyst on carbon support being 30-60% of metal on carbon.

Second step involves preparation of slurry using a combination of electrocatalyst in a suspension containing solubilized form of the polymeric network material (structures 1-2). Additionally, pore forming components based on a combination of carbonates and bicarbonates are added in a ratio of 5-10% by weight. The ratio of the components has a variation of 10-30% within choice of each component enabling a total catalyst loading 0.01 to 0.5 mg of Pt or Pt alloy/cm². The application of the slurry is achieved via a combination or exclusive application of calendaring, screen printing or spraying.

Catalyst application so achieved in the form of a reaction layer is followed by third step which comprises of sintering and drying of electrode layer. In this step the electrodes are subjected to a two step process which initially involves drying at 160° C. for about 30 minutes followed by sintering at temperatures in the range of 150-350° C. for a time period in the range of 30 minutes to 5 hours.

### Formation of Membrane Electrode Assembly

To prepare membrane electrode assemblies (MEAs), a sandwich of anode membrane and cathode electrodes is placed in an appropriate arrangement of gasket materials, typically a combination of polyimide and polytetrafluorethylene (PTFE, Dupont, USA). This is followed by hot pressing with a hydraulic press or other similar device. Pressures in the range of 0.1 to 10 bars are applied with platen temperatures in the range of 150 to 250° C. for time periods typically in the range of 10 to 60 minutes. The prepared membrane electrode assemblies have thickness in the range of 75 to 250 micro meters. This allows for a final assembly of the membrane electrode assembly. The polymer electrolyte that is used for the preparation of these MEAs is selected from the US Patents applications 20060909151049, 20060909152523, 20060909154641 and 20060912150631.

What is claimed is:

1. A multifunctional material comprising the general structural formula: 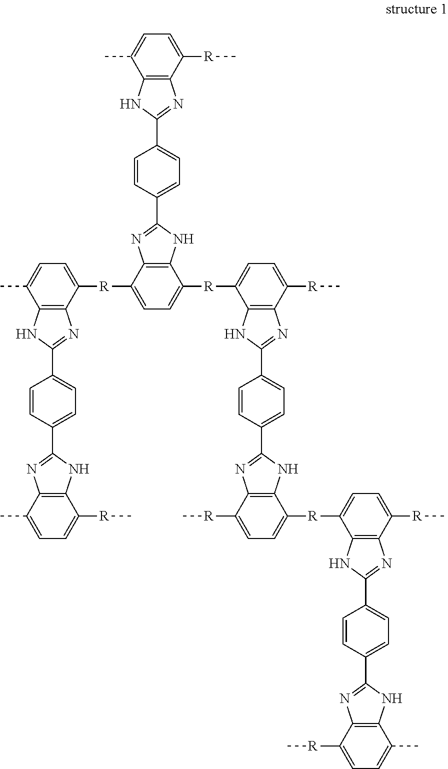
wherein R is selected from the group consisting of:

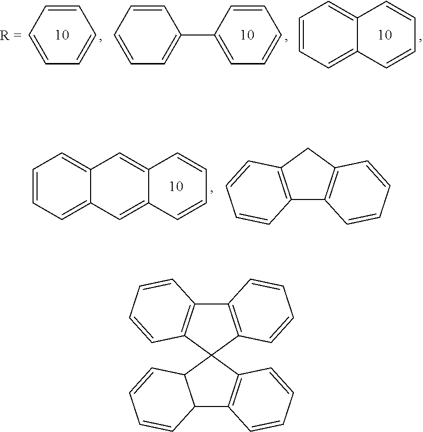

2. A multifunctional material comprising the general structural formula: 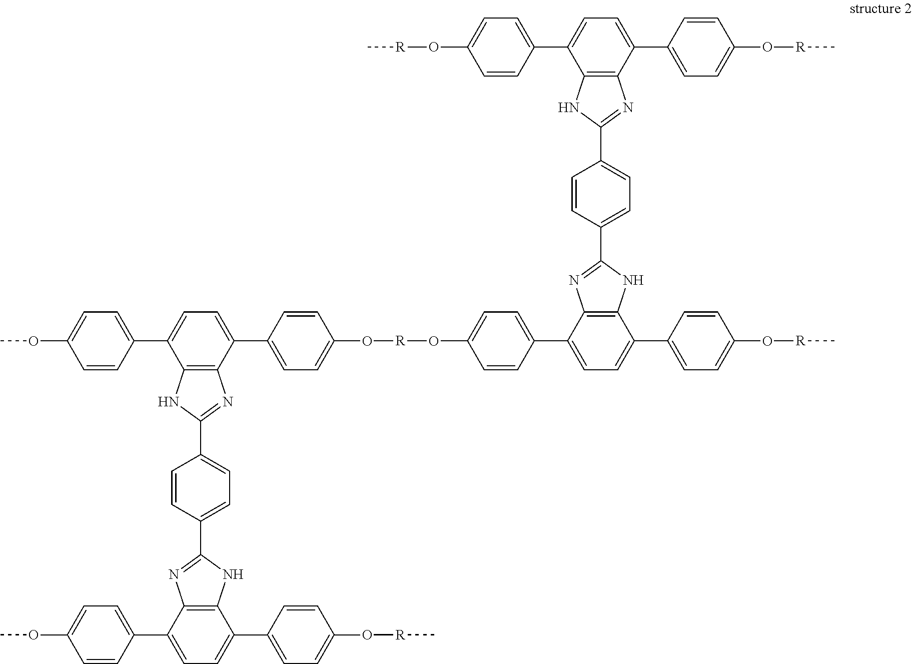
wherein R can be the same or different and is selected from the group consisting of:

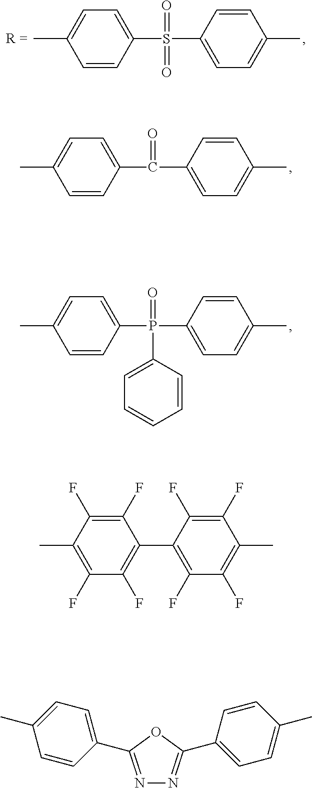

3. The polymer network of claim 1 prepared by a process that comprises Suzuki or Stille cross coupling polymerization reaction of the tetrabromo bisbenzimidazole monomer with either boronic acids (esters) or distannyl derivatives containing phenyl, biphenyl, naphthalene, anthracene, fluorene and spirofluorene under conditions such that the polymer network 1 is formed.

4. The polymer network of claim 2 prepared by a process that comprises polycondensation of the benzimidazole diol monomer and various aromatic difluorides at high temperature under conditions such that the polymer network is foamed.

5. The process of claim 4, wherein the various aromatic difluorides are bis-(4-fluorophenyl)sulfone, bis-(4-fluorophenyl)phenylphosphine oxide, 4,4′-difluorobenzophenone, decafluorobipheynyl, 2,5-bis(4-fluorophenyl)-1,3,4-oxadiazole.

6. A composition comprising a slurry mixture of the polymer network materials, or blend of claims 1 and 2 and a polar aprotic solvent.

7. A method of preparing a catalyst utilizing the composition of claim 6, the method comprising:
(a) depositing a layer of the composition by calendaring, screen printing or spraying on a hydrophobic layer; and
(b) drying and sintering the layer deposited in step (a), thereby preparing the catalyst.

8. A layered membrane electrode assembly, comprising:
the materials of claims 1 and/or 2;
a substrate layer;
a gas diffusion layer; and
a reaction layer.

9. The layered membrane electrode assembly of claim 8 being a component of a fuel cell.
